(19) United States
(12) Patent Application Publication
(10) Pub. No.: US 2018/0053370 A1
(43) Pub. Date: Feb. 22, 2018

(54) FUEL DISPENSING ENVIRONMENT UTILIZING IMPROVED WIRELESS NETWORK TOPOLOGY

(71) Applicant: Gilbarco Inc., Greensboro, NC (US)

(72) Inventors: Rodger K. Williams, Siler City, NC (US); Edward A. Payne, Kernersville, NC (US)

(21) Appl. No.: 15/680,634

(22) Filed: Aug. 18, 2017

Related U.S. Application Data
(60) Provisional application No. 62/376,705, filed on Aug. 18, 2016.

(51) Int. Cl. G07F 15/00; G06Q 20/40; G06Q 20/20

(52) U.S. Cl. CPC G07F 15/001; G06Q 20/202; G06Q 20/401; G06Q 20/405

(57) ABSTRACT

A retail fueling environment comprising a plurality of fuel dispensers located in a forecourt area of the fueling environment. A central controller operative to communicate with a remote payment authorization system to authorize payment of fueling transactions is also provided. The fuel dispensers and the central controller have a respective wireless communication device associated therewith such that the fuel dispensers can communicate with the central controller via wireless transmission. Preferably, the wireless transmission utilizes 802.11p protocol.

### PRIORITY CLAIM

This application is based upon and claims priority to U.S. provisional application Ser. No. 62/376,705, filed Aug. 18, 2016, which is relied upon and incorporated fully herein by reference for all purposes.

### FIELD OF THE INVENTION

The present invention relates generally to service stations at which fuel is dispensed. More particularly, the present invention relates to a system and method for wireless communication between devices in a retail fueling environment.

### BACKGROUND

Retail fueling environments usually include a plurality of fuel dispensers located in a forecourt area outside of a convenience store building. Typically, the fuel dispensers will each be equipped with pay-at-the-pump capability by which the customer can perform the fueling transaction using a user interface on the respective fuel dispenser. For example, the customer can present a credit or debit card using a card reader installed on the fuel dispenser's user interface to pay for the fuel without entering the store. In other cases, the customer may want or need to go into the convenience store to pay for the fuel or to purchase other items.

The convenience store will generally be equipped with a point-of-sale (POS) system to handle certain functions relating to transactions that occur in the retail fueling environment. For instance, the POS may include software components adapted to display a graphical user interface (GUI). Transactions are recorded using the POS for inventory reconciliation and other recordkeeping purposes. In addition, the POS may allow the station's manager the ability to set options associated with the POS or the service station, such as the appearance of receipts issued by the station's dispensers.

Traditionally, the POS and dispensers have communicated using a legacy communication protocol passed along underground wiring. In some cases, attempts have been made to incorporate wireless fidelity (“Wi-Fi”) technology to enable devices within the fueling environments to communicate. Generally speaking, issues have arisen with the use of such wireless technology in a forecourt fuel dispenser environment due to security and line of sight issues or concerns. 802.11a/n/g wireless networking posed issues that were expensive to overcome or exposed security weaknesses that could compromise the forecourt connectivity or allow potential fraud (e.g., listening for transaction or other personal data by hacking into the forecourt network).

### SUMMARY OF CERTAIN ASPECTS

The present invention recognizes and addresses the foregoing considerations, and others, of prior art construction and methods. In this regard, certain exemplary and nonlimiting aspects of the present invention will now be described. These aspects are intended to provide some context for certain principles associated with the present invention, but are not intended to be defining of the full scope of the present invention.

Certain aspects of the present invention are directed to a retail fueling environment comprising a plurality of fuel dispensers located in a forecourt area of a fueling environment. A central controller is operative to communicate with a remote payment authorization system to authorize payment of fueling transactions and to control operation of the fuel dispensers. The fuel dispensers and the central controller each have a respective wireless communication device associated therewith such that the fuel dispensers communicate with the central controller via wireless transmission. The wireless transmission utilizes an ad-hoc protocol that establishes communication between devices on a one-to-one basis. For example, the ad hoc protocol may preferably be 802.11p protocol.

In an exemplary embodiment, the fuel dispensers are further operative to establish a one-to-one wireless connection with a vehicle adjacent thereto. In an exemplary embodiment, the central controller exchanges augmented legacy commands with the fuel dispensers, the augmented legacy commands including a legacy command and a digital signature. The augmented legacy commands may be encrypted. The first fuel dispenser may wirelessly communicate with the central controller via a second fuel dispenser.

In some exemplary embodiments, the central controller comprises an enhanced dispenser hub including an integral payment server. A point of sale (POS) system may be in electrical communication with the enhanced dispenser hub.

Different systems and methods of the present invention utilize various combinations of the disclosed elements and method steps as supported by the overall disclosure herein. Thus, combinations of elements other than those discussed above may be claimed. Moreover, the accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a diagrammatic representation of a retail fueling environment incorporating certain aspects of the present invention.

FIG. 2 is a diagrammatic representation showing additional details of the enhanced dispenser hub of FIG. 1.

FIG. 3 is a diagrammatic representation showing additional details of a fuel dispenser shown in FIG. 1.

FIG. 4 is a diagrammatic representation showing communication between a fuel dispenser and a POS (and/or EDH) in accordance with an embodiment of the present invention.

FIG. 5 is a diagrammatic representation showing communication between a first fuel dispenser and one or many other fuel dispensers in accordance with an embodiment of the present invention.

FIG. 6 is a diagrammatic representation showing communication between a first fuel dispenser and one or many vehicles in the forecourt in accordance with an embodiment of the present invention.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

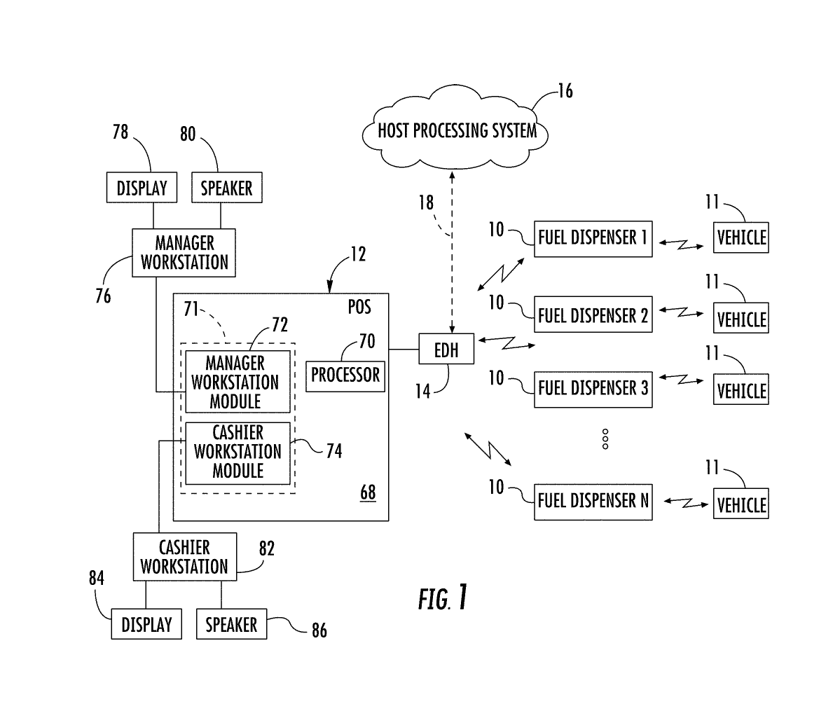

Embodiments of the present invention allow secure communication between the dispenser and POS (or other connected device), and overcome the line of sight issue with traditional WI-FI thereby guaranteeing a reliable connection. In this regard, FIG. 1 illustrates an exemplary retail fueling environment in accordance with an embodiment of the present invention. One or more fuel dispensers 10 are located in the forecourt region of the retail fueling environment. The fuel dispensers are operative to dispense fuel supplied from one or more underground storage tanks (USTs) into a customer's vehicle 11. Typically, the fuel dispensers will be provided with “pay-at-the-pump” capability, allowing the customer to authorize and pay for the fueling transaction at the dispenser itself. The retail fueling environment also includes a point-of-sale (POS) system 12 that handles in-store sales activities, as well as various inventory and configuration functions.

Although embodiments are contemplated in which the electronic payment server is incorporated into or is in direct communication with POS 12, the illustrated embodiment utilizes an enhanced dispenser hub (EDH) 14 as shown and described in U.S. Pat. No. 8,438,064 (incorporated fully herein by reference for all purposes). EDH 14 includes an electronic payment server that allows processing of payment card information. In particular, credit (or debit) card information from the fuel dispensers 10 and any in-store card readers is fed to EDH 14, which seeks approval from a remote host processing system 16 via a suitable off-site communication link 18.

Unlike a traditional fueling environment that utilizes underground wiring to provide communication between the fuel dispensers 10 and EDH 14 (and/or POS 12), the illustrated embodiment utilizes wireless communication in which the forecourt devices communicate via ad-hoc, one-to-one connections (e.g., utilizing 802.11p technology) referred to as “Wi-Fi Direct”. The legacy protocols, dispenser commands, and other communication signals are effectively communicated, without non line-of-sight and security issues that have been a concern with previous attempts to effect wireless communication in a fueling environment. For example, dedicated Short Range Communication implemented on the forecourt is 802.11p which will typically allow for 6 Mb/s or more to dispensers and any kiosks. Any dispenser command (e.g., two wire protocol message) that requires or is marked for authentication can be transmitted in secure mode and with a digital signature. Any other commands that do not require authentication may be transmitted in the clear.

Connect time utilizing Wi-Fi Direct is typically around one second or less, and security is enhanced by limitation and specificity of services upon connection being granted. This is in contrast to a typical Wi-Fi Access Point (AP) with router forming a star-type connection, with all devices attached to the router being in full communication and therefore in exposure to other devices. Wi-Fi Direct may establish the one-to-one connection with other suitably equipped devices within a certain radius, e.g., about 200 yards.

In addition, 802.11p technology is currently used in vehicles to provide vehicle-to-infrastructure (V2I) and vehicle-to-vehicle (V2V) connectivity (collectively V2X). Components of the vehicle forecourt (e.g., dispensers 10) can be considered trusted Road Side Units (RSUs), thus allowing connectivity between the forecourt and the vehicle itself (and/or its occupants via the vehicle's infotainment system). (Various devices and methods regarding Vehicle Ad-Hoc Networks (VANETs) are shown and described in U.S. Pat. No. 9,276,743, entitled “Probabilistic Key Distribution in Vehicular Networks with Infrastructure Support,” and U.S. Pat. No. 8,520,695, entitled “Time-Slot-Based System and Method of Inter-Vehicle Communication,” the disclosures of which are fully incorporated by reference herein for all purposes.) Moreover, functions such as payment can be handled, for example, via the occupants' smart phones if there is a connection between the vehicle and the smart phone (e.g., Bluetooth). Various aspects of the use of V2X technology in a fuel dispensing environment are described in copending application Ser. No. 15/642,537, filed Jul. 6, 2017 (entitled “Fuel Dispenser Utilizing Wi-Fi Direct User Interface”) and copending application serial no. 15/643,910, filed July 7, 2017 (entitled “Fuel Dispenser Having Vehicle Software and Information Distribution Capability”), both of which are incorporated fully herein by reference for all purposes.

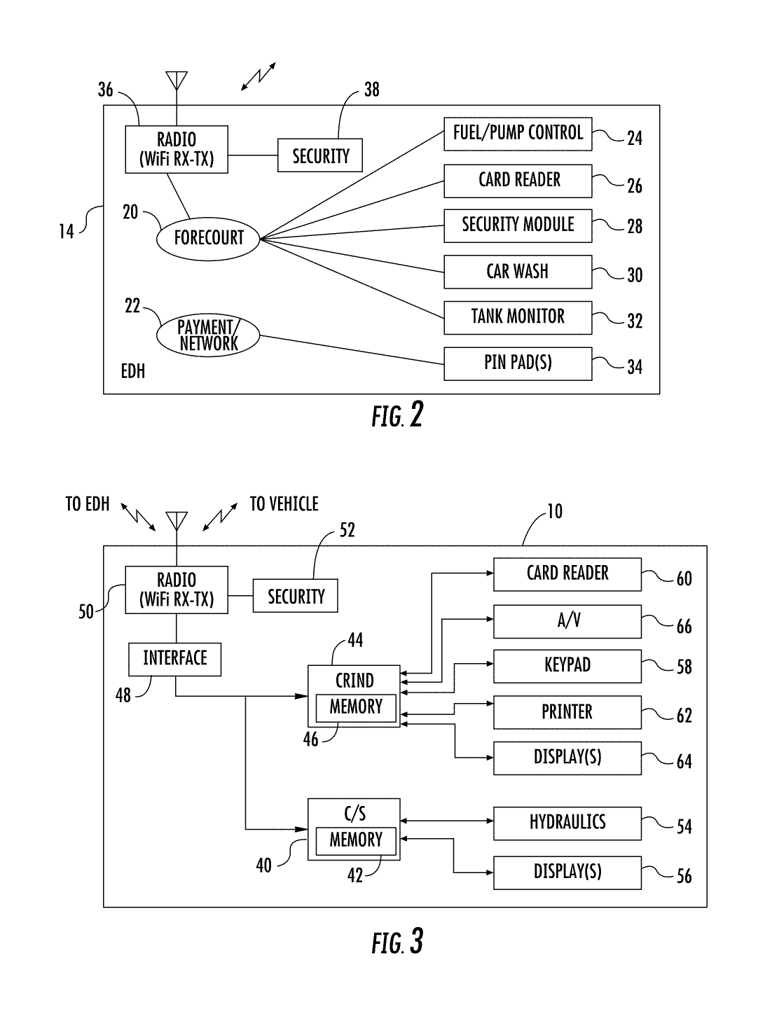

Referring now to FIG. 2, EDH 14 includes one or more processors and associated memory running a forecourt module 20 and a payment module 22. Forecourt module 20 is adapted to control the operation of devices located in the retail fueling environment's forecourt. In this example, forecourt module 20 comprises several modules, including fuel/pump control module 24, card reader module 26, security module 28, car wash module 30, and tank monitor module 32. The fuel/pump control module 24 handles operation of dispensers 10, while the car wash module 30 handles operation of any on-site car washes. The tank monitor module 32 handles operation of any tank monitors connected to the underground storage tanks of the retail fueling environment. The card reader module 26 handles operation of the card readers of the retail fueling environment, such as the card readers of dispensers 10. The security module 28 handles encryption of the sensitive information transmitted by the components of retail fueling environment. For instance, payment card data received by the various card readers in the retail fueling environment may be handled by the card reader module 26 and encrypted by the security module 28.

Payment module 22 performs validation of the payment card information received by the various card readers in the retail fueling environment. In particular, payment module 22 handles communications to and from the host processing system 16. As shown, payment module 22 communicates with a PIN pad module 34 when information from a PIN pad is necessary to process the transaction.

As can be seen, EDH 14 further includes a suitable communication unit 36 that implements wireless communication with other devices in the forecourt, such as dispensers 10. Communication unit 36 is in operative communication with forecourt module 20, and includes appropriate receiver (RX) and transmitter (TX) electronics to modulate and demodulate the wireless signals. A security module 38 is associated with communication unit 36 to encrypt and decrypt the wireless communications as necessary or desired, or to otherwise supply the appropriate validation credentials (e.g., a digital signature).

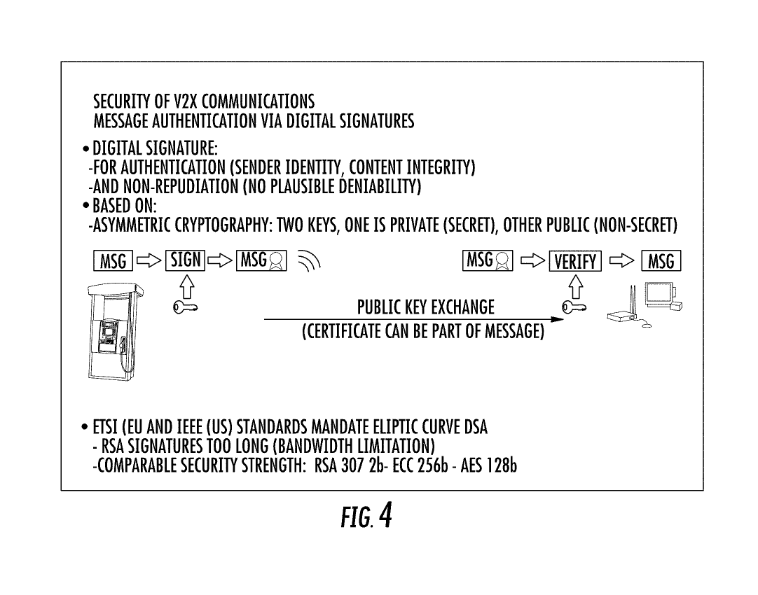

Referring now to FIG. 3, additional details regarding the various components of fuel dispenser 10 can be more easily explained. As shown, fuel dispenser 10 includes a control system 40 having an associated memory 42. In addition, dispenser 10 may also comprise a CRIND (card reader in dispenser) module 44 and associated memory 46. Those of ordinary skill in the art are familiar with CRIND units used in fuel dispensers, but additional background information is provided in U.S. Pat. No. 4,967,366, the entirety of which is incorporated by reference herein for all purposes.

As shown, control system 40 and CRIND module 44 are in operative communication with EDH 14 (and/or POS 12) and via an interface 48. In particular, interface 48 communicates with a wireless communication unit 50 which is similar to communication unit 36. Similar to security module 38, a security module 52 is associated with communication unit 50. As noted above, dispenser 10 may also preferably communicate with an adjacent vehicle as a trusted RSU.

Control system 40 includes the hardware and software necessary to control the hydraulic components and functions of dispenser 10. Those of ordinary skill in the art are familiar with the operation of the hydraulics 54 of dispenser 10. In general, however, fuel from USTs is pumped through a piping network into an inlet pipe. Fuel being dispensed passes through a flow meter, which is responsive to flow rate or volume. A displacement sensor, such as a pulser, is employed to generate a signal in response to fuel flow though the meter and communicate this information to control system 40. Control system 40 may also provide control signaling to a valve that may be opened and closed to permit or not permit dispensing of fuel.

Meter flow measurements from the displacement sensor are collected by control system 40. Control system 40 also typically performs calculations such as cost associated with a fuel dispensing transaction. As a dispensing transaction progresses, fuel is then delivered to a hose and through a nozzle into the customer's vehicle. Dispenser 10 includes a nozzle boot, which may be used to hold and retain the nozzle when not in use. The nozzle boot may include a mechanical or electronic switch in communication with control system 40 to indicate when the nozzle has been removed for a fuel dispensing request and when the nozzle has been replaced, signifying the end of a fueling transaction. Control system 40 may thus determine whether a transaction has been initiated or completed.

Control system 40 may further be operative to control one or more displays 56. For example, a transaction price total display may present customers with the price for fuel that is dispensed. A transaction gallon total display may be used to present customers with the measurement of fuel dispensed in units of gallons (or liters). Finally, price per unit (PPU) displays may be provided to show the price per unit of fuel dispensed in either gallons or liters, depending on the programming of dispenser 10.

CRIND module 44 includes the hardware and software necessary to support payment processing and peripheral interfaces at dispenser 10. In this regard, CRIND module 44 may be in operative communication with several input devices. For example, a PIN pad 58 is typically used for entry of a PIN if the customer is using a debit card for payment of fuel or other goods or services. CRIND module 44 may also be in operative communication with a card reader 60 for accepting credit, debit, or other magnetic stripe cards (or chip cards) for payment. Additionally, card reader 60 may accept loyalty or program-specific cards as is well known. Further, CRIND module 44 may be in operative communication with other payment or transactional devices such as a receipt printer 62.

One or more display(s) 64 may be used to display information, such as transaction-related prompts and advertising, to the customer. The customer may use soft keys to respond to information requests presented to the user via a display 64. In some embodiments, however, a touch screen may be used for display 64. In that case, display 64 may be configured to display a virtual keypad for receiving payment data such as a PIN of a debit card or the billing postal (zip) code of a credit card, for instance. Display 64 may also be used in that case to receive a selection from the customer regarding the displayed information.

Audio/video electronics 66 are adapted to interface with the CRIND module 44 and/or an auxiliary audio/video source to provide advertising, merchandising, and multimedia presentations to a customer in addition to basic transaction functions. The graphical user interface provided by the dispenser may allow customers to purchase goods and services other than fuel at the dispenser. For example, the customer may purchase a car wash and/or order food from the store while fueling a vehicle.

Referring again to FIG. 1, POS 12 includes a server 68 having a processor 70 and associated memory 71. In the present example, processor 70 executes several software modules including manager workstation module 72 and cashier workstation module 74. When executed, manager workstation module 72 displays a GUI on manager workstation 76 that allows the owner, operator, or manager of the fueling station to set options for the fueling environment. Manager workstation module 72 is also adapted to provide point-of-sale (“POS”) capabilities, including the ability to conduct transactions for items offered for sale by the fueling station. Toward this end, manager workstation 76 includes a suitable display 78, such as a touchscreen display, and may further include one or more speakers 80. As one skilled in art will appreciate, server 68 and manager workstation 76 may be incorporated into the same hardware.

Similarly, cashier workstation module 74 provides the station's cashier, clerk, or employee the means necessary to effect a transaction for one or more items or services offered by the fueling station. Cashier workstation module 74 communicates with the hardware of cashier workstation 82, which includes its own display 84 and optional speaker(s) 86.

In operation, a user positions a vehicle adjacent to one of dispensers 10 and uses the dispenser to refuel the vehicle. For payment, the user inserts and removes a payment card from card reader 60. Card reader 60 reads the information on the payment card and transmits the information to forecourt module 20 via card reader module 26. The forecourt module 20 provides the payment information to network payment module 22, which contacts host processing system 16 operated by the financial institution associated with the user's payment card. The financial institution either validates or denies the transaction and transmits such a response to network payment module 22. The information received from the financial institution's host computer system is transmitted from network payment module 22 back to forecourt module 20 to handle appropriately. This may include transmitting to dispenser 10 a request that the user provide another payment card if the transaction is denied, or printing a receipt if authorized.

For additional information regarding retail fueling environments, reference is made to U.S. Pat. No. 6,435,204 (entitled “Fuel Dispensing System”), U.S. Pat. No. 5,956,259 (entitled “Intelligent Fueling”), U.S. Pat. No. 5,734,851 (entitled “Multimedia Video/Graphics in Fuel Dispensers”), U.S. Pat. No. 6,052,629 (entitled “Internet Capable Browser Dispenser Architecture”), U.S. Pat. No. 5,689,071 (entitled “Wide Range, High Accuracy Flow Meter”), and U.S. Pat. No. 6,935,191 (“entitled “Fuel Dispenser Fuel Flow Meter Device, System and Method”), all of which are hereby incorporated by reference for all purposes as if set forth verbatim herein.

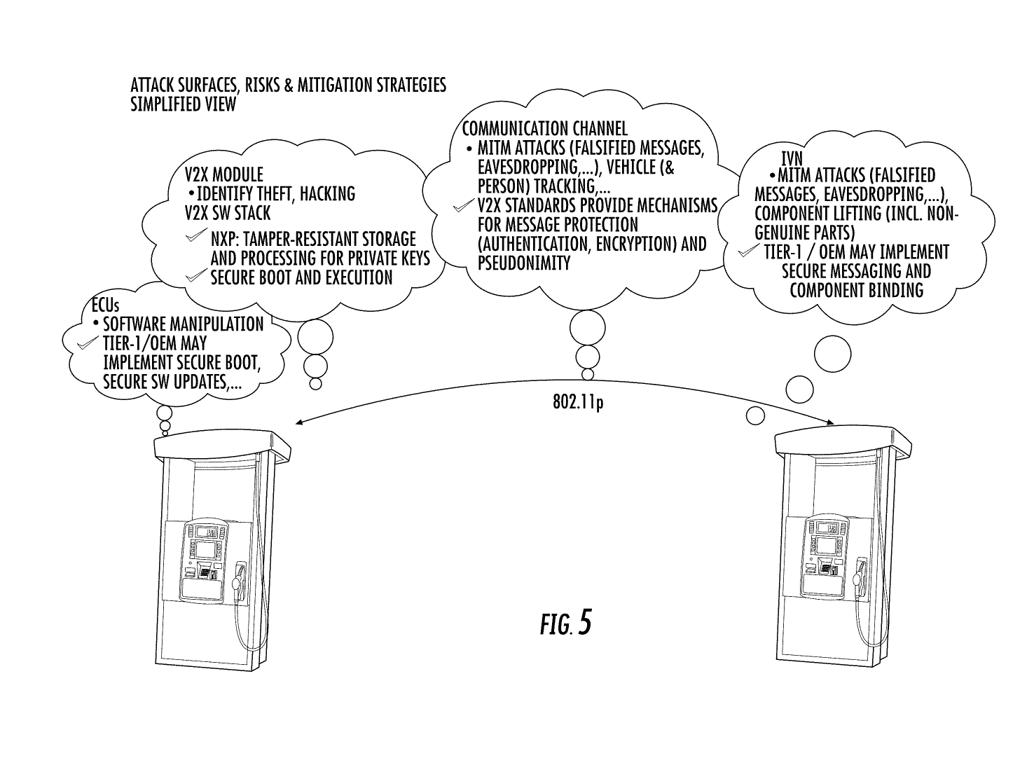

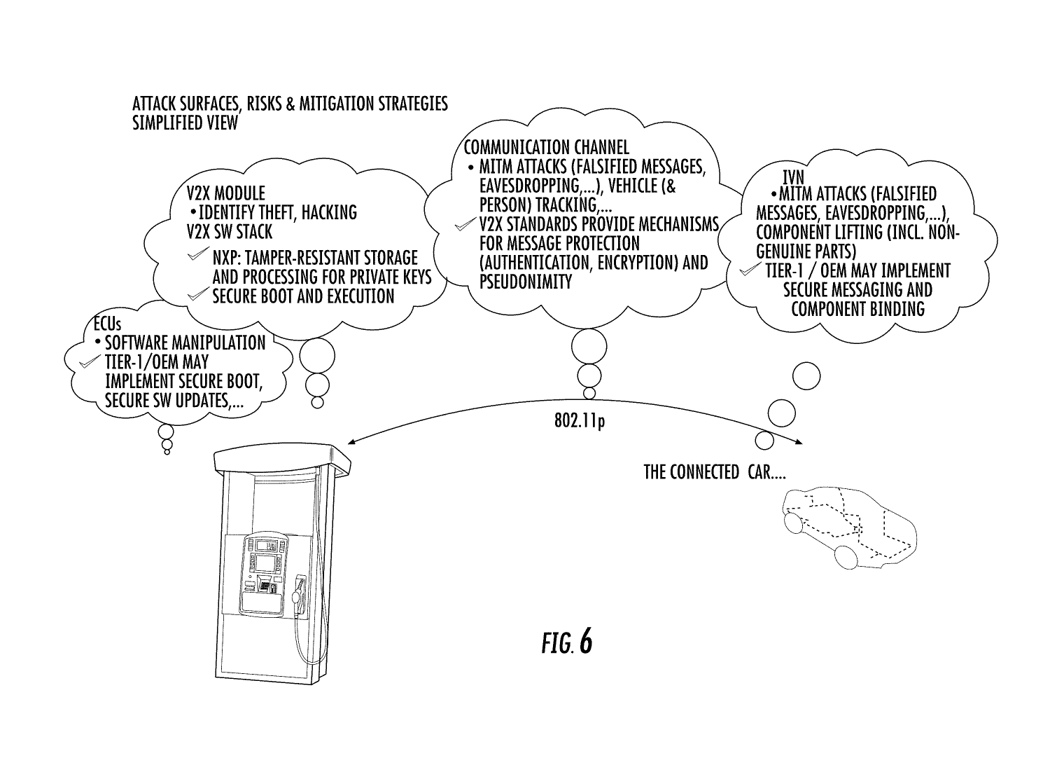

Various additional features of a vehicle forecourt in accordance with aspects of the present invention are shown in FIGS. 4-6.

Additional aspects of a fueling environment forecourt utilizing wireless communication between and among its components are shown and described in U.S. Pub. No. 20130103585, incorporated fully herein by reference for all purposes.

While one or more preferred embodiments of the invention have been described above, it should be understood that any and all equivalent realizations of the present invention are included within the scope and spirit thereof. While much of the discussion above has involved fuel as the exemplary product being dispensed, one skilled in the art will recognize that aspects of the present invention are applicable to a wide variety of different goods and services. Thus, the embodiments depicted are presented by way of example only and are not intended as limitations upon the present invention. For example, many aspects of the present invention are described above in the exemplary context of a retail fueling environment. It should be understood by those of ordinary skill in this art, however, that the present invention is not limited to these embodiments because other commercial environments are contemplated and modifications can be made. Therefore, it is contemplated that any and all such embodiments are included in the present invention as may fall within the scope and spirit thereof.

What is claimed is:

1. A retail fueling environment comprising:
a plurality of fuel dispensers located in a forecourt area of said fueling environment;
a central controller operative to communicate with a remote payment authorization system to authorize payment of fueling transactions and to control operation of the fuel dispensers;
said fuel dispensers and said central controller having a respective wireless communication device associated therewith such that said fuel dispensers communicate with said central controller via wireless transmission; and
wherein said wireless transmission utilizes an ad-hoc protocol that establishes communication between devices on a one-to-one basis.

2. A retail fueling environment as set forth in claim 1, wherein said ad hoc protocol is 802.11p protocol.

3. A retail fueling environment as set forth in claim 1, wherein each of said fuel dispensers is further operative to establish a one-to-one wireless connection with a vehicle adjacent thereto.

4. A retail fueling environment as set forth in claim 1, wherein said central controller exchanges augmented legacy commands with the fuel dispensers, said augmented legacy commands including a legacy command and a digital signature.

5. A retail fueling environment as set forth in claim 4, wherein said augmented legacy commands are encrypted.

6. A retail fueling environment as set forth in claim 4, wherein a first fuel dispenser wirelessly communicates with said central controller via a second fuel dispenser.

7. A retail fueling environment as set forth in claim 1, wherein said central controller comprises an enhanced dispenser hub including an integral payment server.

8. A retail fueling environment as set forth in claim 8, further comprising a point of sale (POS) system in electrical communication with said enhanced dispenser hub.
